(19) United States
(12) Patent Application Publication
(10) Pub. No.: US 2006/0266792 A1
(43) Pub. Date: Nov. 30, 2006

(54) Multi-chip die bonder and method

(76) Inventors: Youn-Sung Ko, Cheonan-si (KR); Choo-Ho Kim, Yongin-si (KR); Hyun-Ho Kim, Cheonan-si (KR); Yong-Kyun Sun, Cheonan-si (KR); Byung-Joon Lee, Seongnam-si (KR); Il-Sup Choi, Suwon-si (KR); Jung-Hwan Woo, Cheonan-si (KR)

Correspondence Address: HARNESS, DICKEY & PIERCE, P.L.C., P.O. BOX 8910, RESTON, VA, 20195, US

(21) Appl. No.: 11/255,912

(22) Filed: Oct. 24, 2005

(30) Foreign Application Priority Data
May 30, 2005 (KR) 2005-45558

(51) Int. Cl. B23K 1/00; B23K 5/00

(52) U.S. Cl. 228/6.2

(57) ABSTRACT

A multi-chip die bonder may include a first substrate conveyor conveying a substrate in a first direction and a second substrate conveyor conveying a substrate in a second direction. A plurality of dies may be stacked onto the substrate while the substrate is circulating the first substrate conveyor and the second substrate conveyor. A first heater may be provided in a die bonding unit and a second heater may be provided in the first substrate conveyor. An adhesive curing process may be performed together with a die attaching process.

### PRIORITY STATEMENT

This U.S. non-provisional application claims benefit of priority under 35 U.S.C. §119 from Korean Patent Application No. 2005-45558, filed on May 30, 2005, the entire contents of which are incorporated herein by reference.

### BACKGROUND

1. Field of the Invention

Example embodiments of the present invention relate in general to a semiconductor device manufacturing apparatus, and more particularly, to a multi-chip die bonder.

2. Description of the Related Art

In the manufacture of semiconductor devices, die bonding may involve separating a semiconductor die, often referred to as a chip, from a wafer and attaching the die to a substrate using an adhesive. Example adhesives may include adhesive tape and liquid adhesive. Liquid adhesives may be cured after die bonding.

A conventional die bonder (referred to as a single die bonder) may attach a single die to a substrate. For example, as shown in FIG. 1, a multi-chip stack may include a plurality of dies 74, 76, 94 and 96 on a substrate 11. To provide the multi-chip stack, the single die bonder may repeat a die attaching process and a substrate loading/unloading process.

To attach n (n being a natural number) dies to a substrate, the single die bonder may perform n die attaching processes, each of which may involve an associated substrate loading/unloading process (for a total of n substrate loading/unloading processes), thereby increasing the process time.

To avoid the shortcomings associated with the single die bonder, a dual die bonder may be implemented. The dual die bonder may attach two dies to a substrate using only a single substrate loading/unloading process. However, the dual die bonder may have difficulty in attaching three or more dies to a substrate. In this case, the dual die bonder may repeat a substrate loading/unloading process for a single multi-chip stack.

As one possible solution, the quantity of die bonding sections of the dual die bonder may be increased according to the desired quantity of dies to be applied to the substrate. However, the increased quantity of die bonding sections may cause an enlargement of the space occupied by the dual die bonder.

The dual die bonder may cure two different mediums, thereby reducing the curing time. However, a first die may be provided on a liquid adhesive before a curing process, and a second die may be provided on the first die. Since the liquid adhesive may not be cured, the liquid adhesive may flow due to pressure that may be applied to the first die. As a result, the first die and/or the second die may be inadvertently moved to unintended positions. The positional faults of the dies may adversely influence a subsequent wire bonding process.

### SUMMARY

According to an example, non-limiting embodiment, a multi-chip die bonder may include a first substrate conveyor having a starting section and a final section for conveying a substrate in a first direction. A die attaching unit may be provided for attaching dies to the substrate. A second substrate conveyor having a starting section and a final section may be provided for conveying the substrate in a second direction that is parallel to the first direction. A first transfer unit may be provided for transferring the substrate from the final section of the second substrate conveyor to the starting section of the first substrate conveyor. A second transfer unit may be provided for transferring the substrate from the final section of the first substrate conveyor to the starting section of the second substrate conveyor. The die attaching unit may stack a plurality of dies on the substrate when the substrate circulates the first substrate conveyor and the second substrate conveyor.

According to another example, non-limiting embodiment, a multi-chip die bonder may include a looping travel path to convey a substrate. At least one die attaching unit may be provided along the looping travel path. The at least one die attaching unit may stack at least one die on the substrate.

According to another example, non-limiting embodiment, a method may involve loading a substrate onto a travel path. The substrate may be conveyed along the travel path so that the substrate passes through an attaching location a plurality of times before being removed from the travel path. A plurality of dies may be attached to the substrate when the substrate is in the attaching location.

### BRIEF DESCRIPTION OF THE DRAWINGS

Example, non-limiting embodiments of the present invention will be readily understood with reference to the following detailed description thereof provided in conjunction with the accompanying drawings, wherein like reference numerals designate like structural elements.

FIG. 1 is a cross-sectional view of a conventional multi-chip stack.

FIG. 2 is a block diagram of a multi-chip die bonder in accordance with an example, non-limiting embodiment of the present invention.

FIG. 3 is a schematic perspective view of a multi-chip die bonder in accordance with an example, non-limiting embodiment of the present invention.

FIG. 4 is a cross-sectional view of a die attaching and curing process that may be performed by the multi-chip die bonder of FIG. 3.

FIG. 5 is a flow chart of a multi-chip stacking process that may be performed by a multi-chip die bonder in accordance with an example, non-limiting embodiment of the present invention.

The drawings are provided for illustrative purposes only and are not drawn to scale. The spatial relationships and relative sizing of the elements illustrated in the various embodiments may have been reduced, expanded or rearranged to improve the clarity of the figure with respect to the corresponding description. The figures, therefore, should not be interpreted as accurately reflecting the relative sizing or positioning of the corresponding structural elements that could be encompassed by an actual device manufactured according to the example, non-limiting embodiments of the invention.

### DETAILED DESCRIPTION OF EXAMPLE, NON-LIMITING EMBODIMENTS

Example, non-limiting embodiments of the present invention will be described more fully with reference to the accompanying drawings. This invention may, however, be embodied in many different forms and should not be construed as limited to the example embodiments set forth herein. Rather, the disclosed embodiments are provided so that this disclosure will be thorough and complete, and will fully convey the scope of the invention to those skilled in the art. The principles and features of this invention may be employed in varied and numerous embodiments without departing from the scope of the invention.

An element is considered as being mounted (or provided) “on” another element when mounted (or provided) either directly on the referenced element or mounted (or provided) on other elements overlaying the referenced element. Throughout this disclosure, spatial terms such as “upper,” “lower,” “above,” “below,” “upper” and “lower” (for example) are used for convenience in describing various elements or portions or regions of the elements as shown in the figures. These terms do not, however, require that the structure be maintained in any particular orientation.

Well-known structures and processes are not described or illustrated in detail to avoid obscuring the present invention.

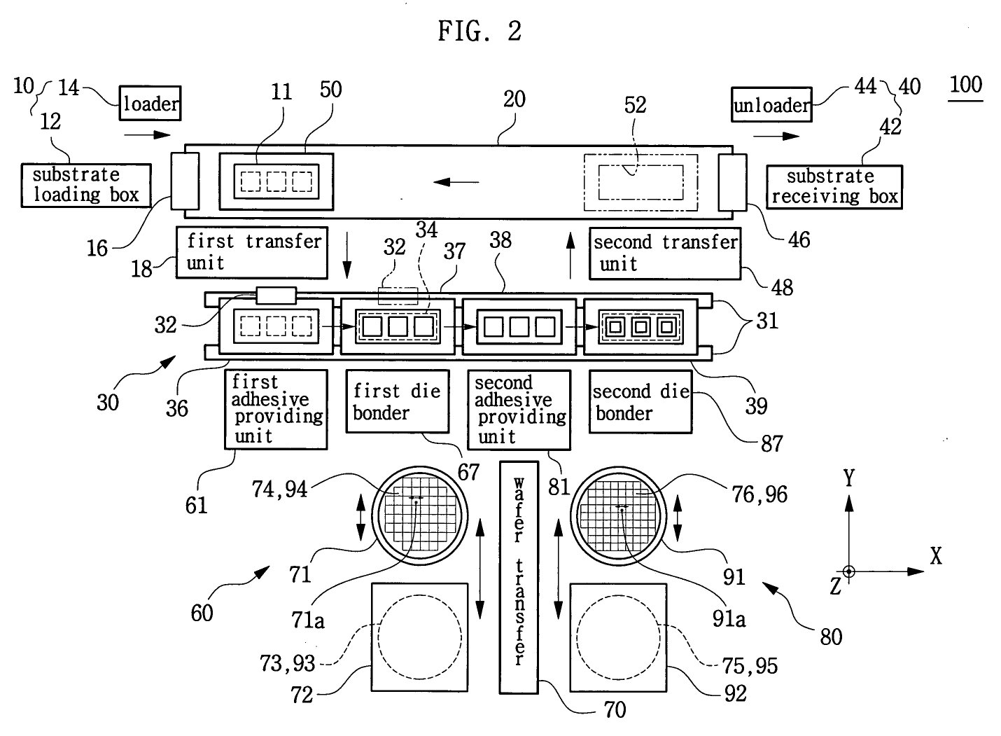

Referring to FIGS. 2 through 4, a multi-chip die bonder 100 may comprise a first substrate conveyor 30 and a second substrate conveyor 20. The first substrate conveyor 30 may extend in a first direction from a starting section to a final section. The second substrate conveyor 20 may extend in a second direction from a starting section to a final section. By way of example only, the first direction may be opposite to the second direction. The starting section of the first substrate conveyor 30 may correspond to the final section of the second substrate conveyor 20. The final section of the first substrate conveyor 30 may correspond to the starting section of the second substrate conveyor 20. The first and the second substrate conveyors 30 and 20 may transport a substrate 11. A shuttle 50 may support the substrate 11 on the first and the second substrate conveyors 30 and 20.

By way of example only, the second substrate conveyor 20 may be installed parallel to the first substrate conveyor 30. The second substrate conveyor 20 may convey the shuttle 50 in an opposite direction to the proceeding direction of the first substrate conveyor 30. The starting section of one of the substrate conveyors may correspond to the final section of the other substrate conveyors. For example, the starting section of the first substrate conveyor 30 may receive the shuttle 50 from the final section of the second substrate conveyor 20, and the starting section of the second substrate conveyor 20 may receive the shuttle 50 from the final section of the first substrate conveyor 30.

The length of the second substrate conveyor 20 may be substantially equal to that of the first substrate conveyor 30. The second substrate conveyor 20 may use a belt conveyor (for example) to convey the shuttle 50 continuously.

Transfer units 18 and 48 may transfer the shuttle 50 between the first substrate conveyor 30 and the second substrate conveyor 20. The transfer units 18 and 48 may include a first transfer unit 18 and a second transfer unit 48. The first transfer unit 18 may transfer the shuttle 50 from the final section of the second substrate conveyor 20 to the starting section of the first substrate conveyor 30. The second transfer unit 48 may transfer the shuttle 50 from the final section of the first substrate conveyor 30 to the starting section of the second substrate conveyor 20.

The first and the second transfer units 18 and 48 may each have a pusher (not shown) for pushing the shuttle 50. The first and the second transfer units 18 and 48 may have similar structures. For convenience, therefore, a transfer operation is described with regard to the first transfer unit 18 only. To avoid mechanical interferences that may occur between the shuttle 50 and the first substrate conveyor 30 and/or between the shuttle 50 and the second substrate conveyor 20, the shuttle 50 may be moved vertically (relative to the first and/or the second substrate conveyors) during a transfer operation. For example, a shuttle 50 on the second substrate conveyor 20 may be moved upwards by an elevator (not shown) of the second substrate conveyor 20. The shuttle 50 may be transferred above the starting section of the first substrate conveyor 30 by the first transfer unit 18. The shuttle 50 may be moved downwards onto the first substrate conveyor 30 by an elevator of the first substrate conveyor 30.

As described above, the substrate 11 may be circulated on the first substrate conveyor 30 and the second substrate conveyor 20 repeatedly so that the desired quantity of dies may be stacked on the substrate 11. In this regard, the first and the second substrate conveyors 30, 20 may cooperate to convey the shuttle 50 and the substrate 11 along a re-circulating (or looping) travel path.

By way of example only, the substrate providing unit 10 may be provided near the final section of the second substrate conveyor 20, and the substrate receiving unit 40 may be provided near the starting section of the second substrate conveyor 20. In an alternative embodiment, the substrate providing unit 10 and the substrate receiving unit 40 may be provided at ends of the first substrate conveyor 30.

The substrate providing unit 10 may include a substrate loading box 12 and a loader 14. The substrate loading box 12 may contain the substrates 11. The loader 14 may load the substrates 11 from the substrate loading box 12 to a vacant shuttle 50 provided at the final section of the second substrate conveyor 20. The shuttle 50 may have a rectangular mounting area 52 (for example).

By way of example only, the substrate 11 may have an elongated shape so that a plurality of semiconductor devices may be formed therefrom. The substrate 11 may include a lead frame, a printed circuit board and/or a tape wiring substrate (for example), and may be loaded in different substrate loading boxes 12 according to type. If the substrate 11 is relatively thin (e.g., a printed circuit board or a tape wiring substrate), then the substrate 11 may be attached to a frame, and the frame having the substrate 11 may be mounted on the shuttle 50.

The shuttle 50 provided with the substrate 11 at the final section of the second substrate conveyor 20 may be transferred to the starting section of the first substrate conveyor 30 by the first transfer unit 18. The first substrate conveyor 30 may include a transfer rail 31 and a clamp 32. The transfer rail 31 may be located below the shuttle 50. The clamp 32 may clamp the shuttle 50 and convey the shuttle 50 for a predetermined distance to facilitate a die attaching process. A rolling mechanism (not shown), for example a bearing, may be provided on the side of the shuttle 50 confronting the transfer rail 31.

The shuttle 50 may be conveyed to the final section of the first substrate conveyor 30, and may be transferred to the starting section of the second substrate conveyor 20 by the second transfer unit 48. Here, the shuttle 50 having the substrate 11 (which has only partially completed a multi-chip die bonding process) may be conveyed to the final section of the second substrate conveyor 20, and may be transferred to the starting section of the first substrate conveyor 30.

The substrate 11 that has completed a multi-chip die bonding process may be unloaded from the shuttle 50. The substrate receiving unit 40 may include an unloader 44 and a substrate receiving box 42. The substrate 11 may be transferred from the shuttle 50 to the substrate receiving box 42 by the unloader 44. The vacant shuttle 50 may be conveyed to the final section of the second substrate conveyor 20 and may be provided with another substrate 11 from the substrate loading box 12.

Cleaners 16 and 46 may remove impurities from the substrate 11. The cleaners 16 and 46 may include a first cleaner 16 and a second cleaner 46. The first cleaner 16 may be provided between the substrate loading box 12 and the final section of the second substrate conveyor 20. The second cleaner 46 may be provided between the starting section of the second substrate conveyor 20 and the substrate receiving box 42. The first cleaner 16 may clean the substrate 11 to be provided to the second substrate conveyor 20 to improve a die attaching property, for example. The second cleaner 46 may clean the substrate 11 to be provided to the substrate receiving box 42 to improve the wire bonding property, for example.

Die attaching units 60 and 80 may be configured to perform a die attaching process. The die attaching units 60 and 80 may include a first die attaching unit 60 and a second die attaching unit 80. By way of example only, the first die attaching unit 60 may attach a first die 74 and a third die 94 to the substrate 11. The second die attaching unit 80 may attach a second die 76 and a fourth die 96 to the first die 74 and the third die 94, respectively. The first and the second die attaching units 60 and 80 may be sequentially arranged along the conveying direction of the first substrate conveyor 30. The first and the second die attaching units 60 and 80 may be located at a side of the first substrate conveyor 30 opposite to a side of the first substrate conveyor 30 confronting the second substrate conveyor 20.

Since the first and the second die attaching units 60 and 80 may have similar structures, only the first die attaching unit 60 is described for convenience.

The first die attaching unit 60 may include a first adhesive providing unit 61, a first wafer table 71, and a first die bonder 67. The first adhesive providing unit 61 may provide a first adhesive 62 to the substrate 11. The first wafer table 71 may support a first wafer 73 having the first dies 74 and/or a third wafer 93 having the third dies 94. The first die bonder 67 may be provided between the first wafer table 71 and the first substrate conveyor 30. The first die bonder 67 may separate the first and the third dies 74 and 94 from the first and the third wafers 73 and 93, respectively, and may bond the first and the third dies 74 and 94 to the first adhesive 62 of the substrate 11. The first die attaching unit 60 may further include a first wafer cassette 72 and a wafer transfer 70. The first wafer cassette 72 may contain the first and the third wafers 73 and 93. The wafer transfer 70 may transfer the first and the third wafers 73 and 93 from the first wafer cassette 72 to the first wafer table 71 (and vice versa).

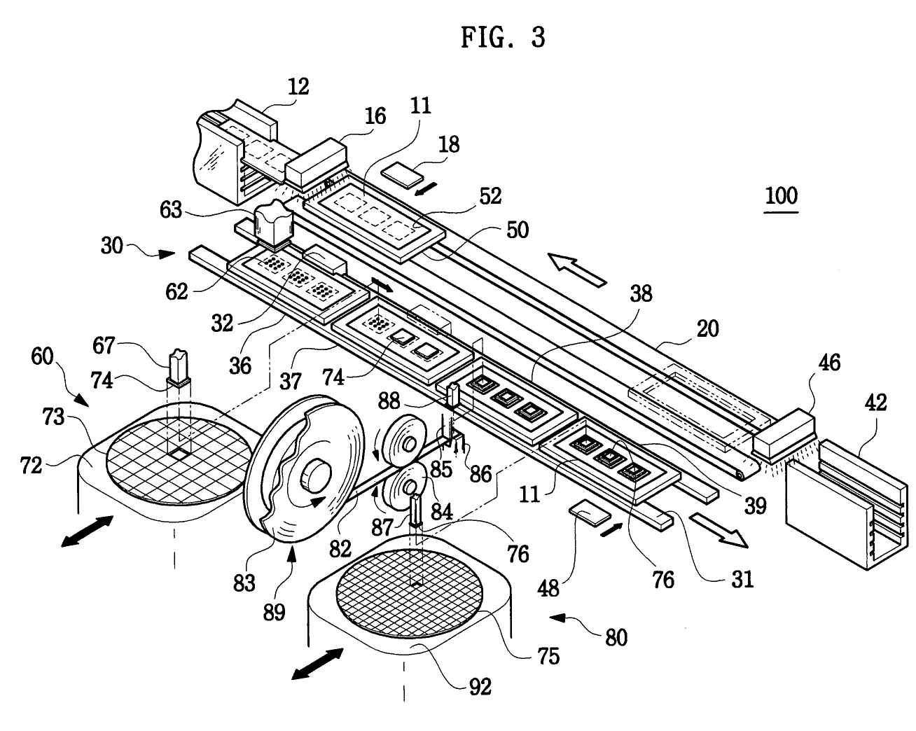

By way of example only, the first adhesive providing unit 61 may include a liquid adhesive provider for providing a liquid adhesive and/or an adhesive tape provider for providing an adhesive tape. An adhesive may be selected from a liquid adhesive and an adhesive tape. FIG. 3 shows an example embodiment of a liquid adhesive provider 63 as the first adhesive providing unit 61 and an adhesive tape provider 88 used as a second adhesive providing unit 81. In alternative embodiments, the first and the second adhesive providing units 61 and 81 may provide the same type of adhesive material.

The liquid adhesive provider 63 may apply a liquid adhesive to the substrate 11 in a dotting method and/or a dispensing method (for example). The liquid adhesive may include a conductive adhesive, for example Ag-epoxy, Ag-glass or solder, and/or a silicon-based nonconductive adhesive.

The adhesive tape provider 88 may include a tape providing assembly 89 for providing an adhesive tape 82. The tape providing assembly 89 may include a reel 83 on which the adhesive tape 82 is wound, and a tape cutter 85 for cutting the adhesive tape 82. The tape providing assembly 89 may further include rollers 84 for providing the adhesive tape 82 to the tape cutter 85, and a tape support 86 for fixing the cut adhesive tape 82 by suction (for example).

The adhesive tape 82 may be provided from the reel 83 to the tape cutter 85 through the rollers 84. The tape cutter 85 may cut the adhesive tape 82 in conformity with the size of the die. By way of example only, the adhesive tape 82 may include a two-sided adhesive tape of polyimide.

The wafer transfer 70 may be provided between the first wafer cassette 72 and a second wafer cassette 92. The wafer transfer 70 may transfer second and fourth wafers 75 and 95, respectively from the second wafer cassette 92 to the second wafer table 91 (and vice versa).

The first wafer cassette 72 and/or the second wafer cassette 92 may contain different types of wafers. In the example embodiment, each of the first and the second wafer cassettes includes two different types of wafers. In alternative embodiments, each of the first and the second wafer cassettes may include more or less than two different types of wafers. Moreover, the first wafer cassette 72 may contain a different number of wafer types that the second wafer cassette 92. The wafer transfer 70 may transfer the different types of the wafers 73, 75, 93 and 95 from the first wafer cassette 72 and/or the second wafer cassette 92 to the first wafer table 71 and/or the second wafer table 91 (and vice versa). By way of example only, the first and the third wafers 73 and 93 may be loaded in the first wafer cassette 72 and the second and the fourth wafers 75 and 95 may be loaded in the second wafer cassette 92 so as to stack the first through fourth dies 74, 76, 94 and 96 on the substrate 11 in consecutive order. In alternative embodiments, the first through fourth dies 74, 76, 94 and 96 may be stacked on the substrate 11 in a different order.

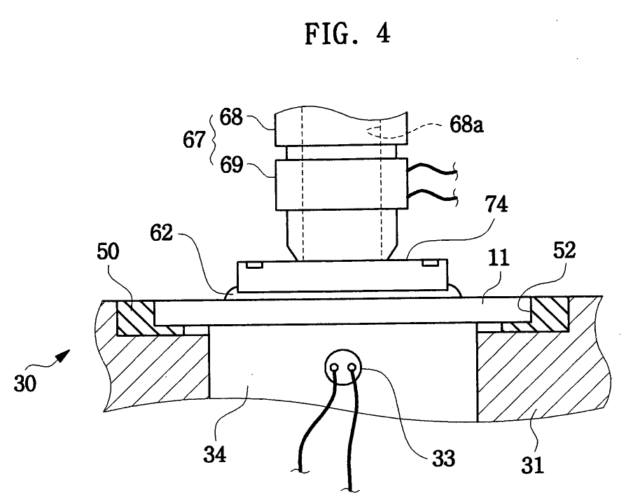

With reference to FIG. 4, the first die bonder 67 may include a first collet 68 and a first heater 69. The first collet 68 may separate the first and the third dies 74 and 94 from the first and the third wafers 73 and 93 on the first wafer table 71 by suction (for example), and may bond the first and the third dies 74 and 94 to the first adhesive 62 of the substrate 11. The first heater 69 may heat the first collet 68 and may transmit heat to the dies 74 and 94 to cure the first adhesive 62. The first heater 69 may include a ceramic heater (for example) which may be mounted on the outer surface of the first collet 68.

As shown in FIG. 2, a first pin 71a may be provided below the first and/or the third wafers 73 and 93 supported by the first wafer table 71. The first pin 71a may push the first and/or the third dies 74 and 94 upwards so that the first die bonder 67 may easily separate the first and/or the third dies 74 and 94 from the first and/or the third wafers 73 and 93. By way of example only, the first wafer table 71 may move in the direction of a Y axis and the first pin 71a may move in the directions of X and Z axes, thereby reducing the movement of the first wafer table 71.

In an alternative embodiment, the first wafer table 71 may be fixed and the first pin 71a may move in the directions of X, Y and Z axes. In another alternative embodiment, the first pin 71a may in the direction of the Z axis and the first wafer table 71 may move in the directions of X and Y axes. The latter case may result in increased space for X and Y axis movements of the first wafer table 71.

Turning back to FIG. 4, a second heater 33 may be provided in the first substrate conveyor 30 and configured to supply heat for curing the first adhesive 62. While the second heater 33 heats the substrate 11 at a predetermined temperature, the first die bonder 67 may attach the first and/or the third dies 74 and 94 to the substrate 11 using a thermocompressing method (for example).

A portion of the first substrate conveyor 30 that may be heated by the second heater 33 may be referred to as a heater block 34. The heater block 34 of the first substrate conveyor 30 may directly contact a lower surface of the substrate 11. The heater block 34 may be of a sufficient size so as to cover the first and/or the third dies 74 and 94 mounted on the substrate 11. A controller (not shown) may be provided to monitor the temperature of the first collet 68 and the heater block 34 and to control the temperature suitable for curing the first adhesive 62.

Since the first and the second die attaching units 60 and 80 may be arranged in the conveying direction of the first substrate conveyor 30, the first die 74 and the second die 76 may be stacked on the substrate 11 in consecutive order.

A single shuttle 50 or a plurality of shuttles 50 for a multi-chip stack may be suitably implemented. Consider an example scenario in which five shuttles 50 may be provided. Here, four shuttles 50 may be provided on the first substrate conveyor 30 and one shuttle 50 may be provided on the second substrate conveyor 20.

For example, of the four shuttles 50 that may be provided on the first substrate conveyor 30, the first shuttle 50 may be positioned for a first adhesive providing process, the second shuttle 50 may be positioned for a first die attaching process, the third shuttle 50 may be positioned for a second adhesive providing process, and the fourth shuttle 50 may be positioned for a second die attaching process. The fifth shuttle 50 provided on the second substrate conveyor 20 may be ready for a transfer to the first substrate conveyor 30, or be provided to the substrate providing unit 10 or the substrate receiving unit 40.

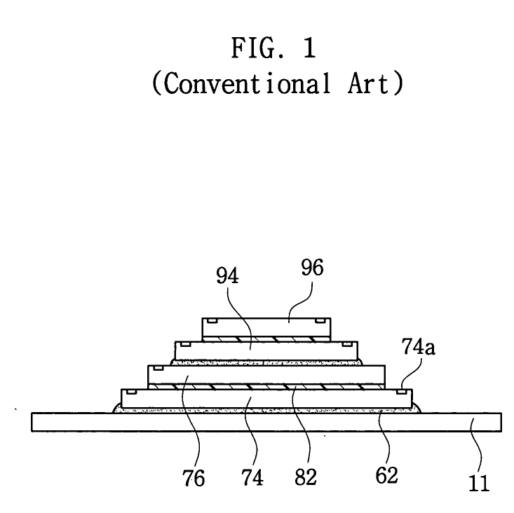

An example method for stacking a plurality of dies 74, 76, 94 and 96 on a substrate 11 using the multi-chip die bonder 100 will be described with reference to FIGS. 1 through 5.

The first substrate conveyor 30 may include four areas, for example. A first area 36 may be the location at which a first adhesive providing process may be performed, a second area 37 may be the location at which a first die attaching process may be performed, a third area 38 may be the location at which a second adhesive providing process may be performed and a fourth area 39 may be the location at which a second die attaching process may be performed. Here, the first area 36 may be the starting section of the first substrate conveyor 30 and the fourth area 39 may be the final section of the first substrate conveyor 30. A shuttle 50 may be provided on each of the first through fourth areas 36, 37, 38, and 39.

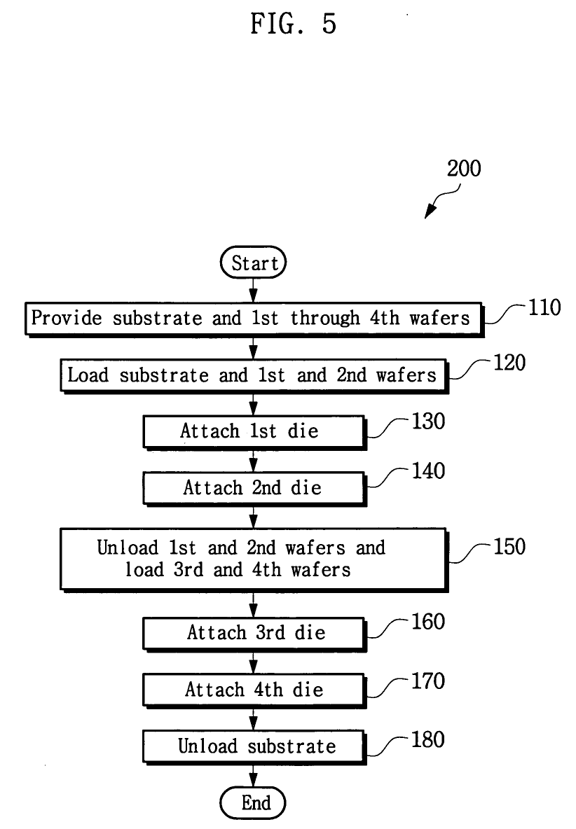

Process for Providing Substrate and First Through Fourth Wafers (110 of FIG. 5)

A multi-chip stacking process may involve providing a substrate and first through fourth wafers 73, 75, 93 and 95.

A substrate loading box 12 having a plurality of substrates 11 may be provided at the final section of a second substrate conveyor 20. A vacant substrate receiving box 42 may be provided at the starting section of the second substrate conveyor 20. A first wafer cassette 72 containing the first wafers 73 having the first dies 74 and the third wafers 93 having the third dies 94 may be provided. A second wafer cassette 92 containing the second wafers 75 having the second dies 76 and the fourth wafers 95 having the fourth dies 96 may be provided.

Process for Loading Substrate and First and Second Wafers (120 of FIG. 5)

The wafer transfer 70 may transfer the first wafer 73 from the first wafer cassette 72 to the first wafer table 71 and the second wafer 75 from the second wafer cassette 92 to the second wafer table 91. The wafer transfer 70 may simultaneously or individually transfer the first wafer 73 and the second wafer 75.

A loader 14 may transfer the substrate 11 from the substrate loading box 12 to the second substrate conveyor 20. The loader 14 may place the substrate 11 on a vacant shuttle 50 at the final section of the second substrate conveyor 20. The first cleaner 16 may clean impurities of the substrate 11 using plasma (for example).

A first transfer unit 18 may transfer the shuttle 50 from the final section of the second substrate conveyor 20 to the first area 36 of the first substrate conveyor 30.

To prevent mechanical interference between a clamp 32 of the first substrate conveyor 30 and the shuttle 50, the clamp 32 may move from the first area 36 to the second area 37. The clamp 32 may resume its original position after the shuttle 50 is transferred to the first area 36.

By way of example only, when a vacant shuttle 50 reaches the final section of the second substrate conveyor 20, a substrate 11 in the substrate loading box 12 may be provided on the vacant shuttle 50. The shuttle 50 at the first area 36 may move to the second area 37. The shuttle 50 recently loaded with the substrate 11 may be transferred from the final section of the second substrate conveyor 20 to the first area 36.

First Die Attaching Process (130 of FIG. 5)

The liquid adhesive provider 63 of the first adhesive providing unit 61 may provide a first adhesive 62, for example a liquid adhesive, to a surface of the substrate 11 on the first area 36.

The shuttle 50 (supporting the substrate 11 with the first adhesive 62) may be transferred to the second area 37 by the clamp 32. The first die bonder 67 may separate the first die 74 from the first wafer 73. The first die bonder 67 may attach the first die 74 to the first adhesive 62 on the surface of the substrate 11 using a thermocompressing method (for example). The thermocompressing method may involve heating the substrate 11 by the heater block 34 so that the first adhesive 62 may be cured and rendered nonflowable.

The first die attaching process and the first adhesive curing process may lead to reduced positional faults of the first die 74 and/or the second die 76 to be attached to the first die 74. The nonflowable characteristics of the cured first adhesive 62 may maintain the first die 74 in a desired position even when pressure may be applied to the first die 74 during attachment of the second die 76.

Second Die Attaching Process (140 of FIG. 5)

The second die attaching process may proceed in a similar manner as the first die attaching process. Here, the second die 76 may be attached to the first die 74 using a second die bonder 87 of the second die attaching unit 80. The second die 76 may be attached to an active surface of the first die 74 and located between chip pads 74a of the first die 74.

Process for Unloading First and Second Wafers and Loading Third and Fourth Wafers (150 of FIG. 5)

For third and fourth die attaching processes, the substrate 11 having the first and the second dies 74 and 76 may be transferred to the starting section of the second substrate conveyor 20 by the second transfer unit 48.

The substrate 11 may be conveyed to the final section of the second substrate conveyor 20. If the shuttle 50 (at the final section of the second substrate conveyor 20) supports a substrate 11, a substrate 11 from the substrate loading box 12 may not be loaded on the shuttle 50. To this end, for example, a sensor (not shown) may be provided at the final section of the second substrate conveyor 20 to determine whether the shuttle 50 (at the final section of the second substrate conveyor 20) has a substrate 11. A substrate loading process may be controlled by a signal of the sensor. The first transfer unit 18 may transfer the shuttle 50 from the final section of the second substrate conveyor 20 to the first area 36 of the first substrate conveyor 30.

The third wafer 93 instead of the first wafer 73 may be provided on the first wafer table 71. The fourth wafer 95 instead of the second wafer 92 may be provided on the second wafer table 91. The wafer transfer 70 may transfer the first wafer 73 from the first wafer table 71 to the first wafer cassette 72, and the third wafer 93 from the first wafer cassette 72 to the first wafer table 71. The wafer transfer 70 may also transfer the second wafer 75 from the second wafer table 91 to the second wafer cassette 92, and the fourth wafer 95 from the second wafer cassette 92 to the second wafer table 91.

Third Die Attaching Process and Fourth Die Attaching Process (160 and 170 of FIG. 5)

The substrate 11 may move through the first through fourth areas 36, 37, 38 and 39 and undergo the third and the fourth die attaching processes. The third and the fourth die attaching processes may be similar to the second die attaching process to the extent that the die from the wafer may be placed on another die (as opposed to the substrate). Accordingly, a detailed description of the third and the fourth die attaching processes is omitted. The first and the second adhesive providing units 61 and 81 used in bonding the third and the fourth dies 94 and 96 may be a liquid adhesive provider 63 or a tape provider 88 according to the condition of an attaching process.

Substrate Unloading Process (180 of FIG. 5)

The shuttle 50 may be transferred from the fourth area 39 of the first substrate conveyor 30 to the starting section of the second substrate conveyor 20 by the second transfer unit 48. The unloader 44 may separate the substrate 11 from the shuttle 50 and may transfer the substrate 11 to the substrate receiving box 42. A second cleaner 46 may clean the substrate 11 using plasma (for example).

The vacant shuttle 50 may be conveyed to the final section of the second substrate conveyor 20 by the second substrate conveyor 20. The shuttle 50 may be provided with a substrate 11 from the substrate loading box 12 and may be transferred to the first substrate conveyor 30 by the first transfer unit 18. The substrate 11 may undergo the above processes.

Although an example embodiment shows the substrate 11 circulating the first substrate conveyor 30 and the second substrate conveyor 20 twice, the substrate 11 may have 2n (n being a natural number) dies by circulating the first and the second substrate conveyors n times.

In accordance with the example embodiments of the present invention, a multi-chip die bonder may include a first substrate conveyor conveying a substrate in a first direction and a second substrate conveyor conveying a substrate in a second direction. The substrate may circulate the first substrate conveyor and the second substrate conveyor so that a plurality of dies may be attached to the substrate. Therefore, time required for substrate loading/unloading processes may be reduced, thereby reducing the time required for a multi-chip die stacking process. In alternative embodiments, more or less than two substrate conveyors may provide the travel path of the substrate. For example, a single substrate conveyor may define a looping travel path for the substrate.

The multi-chip die bonder may incorporate multi-chip die bonding using two die attaching units. In alternative embodiments, more or less than two die attaching units may be implemented along the travel path of the substrate.

Although example, non-limiting embodiments of the present invention have been described in detail, it will be understood that many variations and/or modifications of the basic inventive concepts, which may appear to those skilled in the art, will still fall within the spirit and scope of the example embodiments of the present invention as defined in the appended claims.

What is claimed is:

1. A multi-chip die bonder comprising:
a first substrate conveyor having a starting section and a final section for conveying a substrate in a first direction;
a die attaching unit for attaching dies to the substrate;
a second substrate conveyor having a starting section and a final section for conveying the substrate in a second direction that is parallel to the first direction;
a first transfer unit for transferring the substrate from the final section of the second substrate conveyor to the starting section of the first substrate conveyor; and
a second transfer unit for transferring the substrate from the final section of the first substrate conveyor to the starting section of the second substrate conveyor,
wherein the die attaching unit stacks a plurality of dies on the substrate when the substrate circulates the first substrate conveyor and the second substrate conveyor.

2. The multi-chip die bonder of claim 1, wherein the die attaching unit includes a first die attaching unit for attaching a first die to a substrate, and a second die attaching unit for attaching a second die to the first die.

3. The multi-chip die bonder of claim 2, wherein the first die attaching unit and the second die attaching unit each includes:
an adhesive providing unit for providing an adhesive;
a wafer table for supporting a wafer; and
a die bonder provided between the wafer table and the first substrate conveyor for separating a die from the wafer and attaching the die to the substrate.

4. The multi-chip die bonder of claim 3, wherein the die bonder includes a collet for separating the die from the wafer on the wafer table by suction, and a first heater for applying heat to the collet to cure the adhesive.

5. The multi-chip die bonder of claim 4, wherein a second heater is provided on the first substrate conveyor for applying heat to a portion of the first substrate conveyor to cure the adhesive.

6. The multi-chip die bonder of claim 3, wherein the first die attaching unit and the second die attaching unit each includes a wafer cassette for containing wafers, the wafer table of the first die attaching unit being located adjacent to the wafer table of the second die attaching unit, and the wafer cassette of the first die attaching unit being located adjacent to the wafer cassette of the second die attaching unit.

7. The multi-chip die bonder of claim 6, further comprising a wafer transfer provided between the wafer cassette of the first die attaching unit and the wafer cassette of the second die attaching unit, for transferring wafers from the wafer cassettes to the wafer tables.

8. The multi-chip die bonder of claim 7, wherein each of the wafer cassettes contains at least two kinds of wafers.

9. The multi-chip die bonder of claim 3, wherein the first die attaching unit and the second die attaching unit each includes a push pin for pushing a die of the wafer on the wafer table upward,
wherein the wafer table moves perpendicular to the first direction and the push pin moves in the first direction.

10. The multi-chip die bonder of claim 1, further comprising a substrate providing unit provided adjacent to the final section of the second substrate conveyor for loading a substrate on the final section of the second substrate conveyor, and a substrate receiving unit provided adjacent to the starting section of the second substrate conveyor for unloading a substrate.

11. The multi-chip die bonder of claim 10, wherein the substrate providing unit includes a substrate loading box for loading the substrate, and a loader for transferring the substrate to the final section of the second substrate conveyor.

12. The multi-chip die bonder of claim 11, wherein the substrate receiving unit includes an unloader for unloading the substrate, and a substrate receiving box for receiving the substrate.

13. The multi-chip die bonder of claim 12, wherein atmospheric pressure plasma cleaners are provided between the substrate loading box and the second substrate conveyor and between the second substrate conveyor and the second substrate receiving box, for cleaning the substrate.

14. The multi-chip die bonder of claim 1, wherein the substrate is mounted on a shuttle that circulates the first substrate conveyor and the second substrate conveyor.

15. A multi-chip die bonder comprising:
a looping travel path to convey a substrate; and
at least one die attaching unit provided along the looping travel path, the at least one die attaching unit to stack at least one die on the substrate.

16. The multi-chip die bonder of claim 15, wherein the looping travel path includes a plurality of substrate conveyors.

17. The multi-chip die bonder of claim 16, wherein the looping travel path include two substrate conveyors to convey the substrate in opposite directions, respectively.

18. The multi-chip bonder of claim 15, wherein the at least one die attaching unit stacks a first kind of die on the substrate during a fist pass of the substrate along the looping travel path, and
the at least one die attaching unit stacks a second kind of die on the substrate during a second pass of the substrate along the looping travel path.

19. A method comprising:
loading a substrate onto a travel path;
conveying the substrate along the travel path so that the substrate passes through an attaching location a plurality of times before removing the substrate from the travel path; and
attaching a plurality of dies to the substrate when the substrate is in the attaching location.

20. The method of claim 19, wherein the travel path is a looping travel path.
